(19) United States
(12) Patent Application Publication
(10) Pub. No.: US 2025/0377692 A1
(43) Pub. Date: Dec. 11, 2025

(54) Foldable Electronic Devices with Modular Components

(71) Applicant: Apple Inc., Cupertino, CA (US)

(72) Inventors: Miao He, Sunnyvale, CA (US); Thomas S. Hulbert, Sunnyvale, CA (US)

(21) Appl. No.: 18/740,368

(22) Filed: Jun. 11, 2024

(51) Int. Cl. G06F 1/16

(52) U.S. Cl. CPC G06F 1/1643

(57) ABSTRACT

An electronic device may include first and second modular components removably coupled to one another along a hinge axis. The first component may include a display and may be configured to operate as a stand-alone electronic device when decoupled from the second component. The display may be movable between a first orientation facing toward the second component and a second orientation facing away from the second component. The second component may have one or more input-output devices and/or other components that are not present in the first component to enhance the functionality of the first component. For example, a photography-focused second component may include a visible light camera aligned with an interchangeable lens. An outdoor-focused second component may include a weather-resistant enclosure that receives the first component and that has a replaceable battery and global positioning system receiver circuitry.

### FIELD

This relates generally to electronic devices and, more particularly, to foldable electronic devices.

### BACKGROUND

Electronic devices have components such as displays and cameras. It can be challenging to incorporate universal components into a single electronic device without making the electronic device overly bulky or cumbersome to use. Conventional electronic devices often sacrifice portability in order to fit more components into an electronic device.

### SUMMARY

An electronic device may include first and second modular components that are capable of operating independently of and separately from one another in one mode while also being configured to physically couple to one another and jointly operate as a single electronic device in another mode.

The electronic device may include first and second modular components removably coupled to one another along a hinge axis. The first component may include a display and an antenna configured for cellular telephone communications. The second component may be one of multiple interchangeable second components that serve different functions when attached to the first component.

The first and second components may rotate relative to one another about one or more axes. The first component may be coupled to the second component in a first orientation in which the display of the first component faces away from the second component and a second orientation in which the display of the first component faces toward the second component. The display of the first component may serve as a viewfinder for a camera in the second component. By allowing the first component to rotate and flip relative to the second component, the angle between the display and the camera may be adjusted and versatile shooting postures may be possible.

The second component may have one or more input-output devices and/or other items that are not present in the first component to enhance the functionality of the first component. For example, a photography-focused second component may include a visible light camera aligned with an interchangeable lens. An outdoor-focused second component may include a weather-resistant enclosure that receives the first component and that has a replaceable battery and location tracking circuitry (e.g., global positioning system receiver circuitry, enhanced global positioning system circuitry, and/or any other suitable long range communication circuitry). An audio-focused component may have a loudspeaker.

### BRIEF DESCRIPTION OF THE DRAWINGS

FIG. 1 is a schematic diagram of an illustrative electronic device having first and second modular components in accordance with some embodiments.

FIG. 2 is a side view of an illustrative electronic device with first and second modular components in a folded configuration in which a display of the first component faces away from the second component in accordance with some embodiments.

FIG. 3 is a side view of an illustrative electronic device with first and second modular components in a folded configuration in which a display of the first component faces toward the second component in accordance with some embodiments.

FIG. 4 is a top view of an illustrative first component of an electronic device configured to operate as a stand-alone electronic device when decoupled from a second component in accordance with some embodiments.

FIGS. 5 and 6 are perspective views of an illustrative electronic device with first and second modular components that allow an angle between a display in the first component and a camera in the second component to be adjusted in accordance with some embodiments.

FIG. 7 is a perspective view of an illustrative electronic device having a first component with a display and a second audio-focused component with a speaker in accordance with some embodiments.

FIG. 8 is a side view of an illustrative electronic device having a first component with a display and a second computing-focused component with hardware that allows the electronic device to couple to an external display while also serving as an input device for the external display in accordance with some embodiments.

FIG. 9 is a perspective view of an illustrative electronic device having a first component with a display and a second outdoor-focused component with a weather-resistant housing and other components for outdoor use in accordance with some embodiments.

FIG. 10 is a perspective view of an illustrative electronic device having a first component with a display and a second photography-focused component with interchangeable lenses and other components for photography in accordance with some embodiments.

FIG. 11 is a perspective view of an illustrative electronic device having a first component with a first display and a second component with a second display that can operate jointly or independently of the first display in accordance with some embodiments.

FIG. 12 is a side view of an illustrative electronic device with modular first and second components that rotate relative to one another about a first axis and that can rotate relative to a stand member about a second axis in accordance with some embodiments.

### DETAILED DESCRIPTION

An electronic device may include one or more modular and interchangeable components. For example, an electronic device may include first and second modular components that removably couple to one another. When decoupled from one another, the first and second components may be configured to operate independently of one another as stand-alone electronic devices. When coupled together, the first and second components may be configured to operate in a joint operating mode in which input-output devices and other resources are shared between the two components. The first component may include a touch-sensitive display and may be configured to mate with and jointly operate with multiple different types of interchangeable second components with different functions. For example, the second component may be a photography-focused module, an outdoor-focused module, an audio-focused module, and/or any other suitable module with input-output components and other circuitry that complement or otherwise enhance the input-output components and circuitry of the first component.

The first and second components may be coupled to one another using one or more attachment structures such as hinges, clips, magnets, mating engagement structures, and/or other attachment structures. In one illustrative arrangement, the first and second components may be coupled to one another by a hinge that allows the first and second components to rotate relative to one another about a hinge axis. If desired, the first component may be configured to swivel about one or more additional axes to allow a display in the first component to face toward or away from the second component.

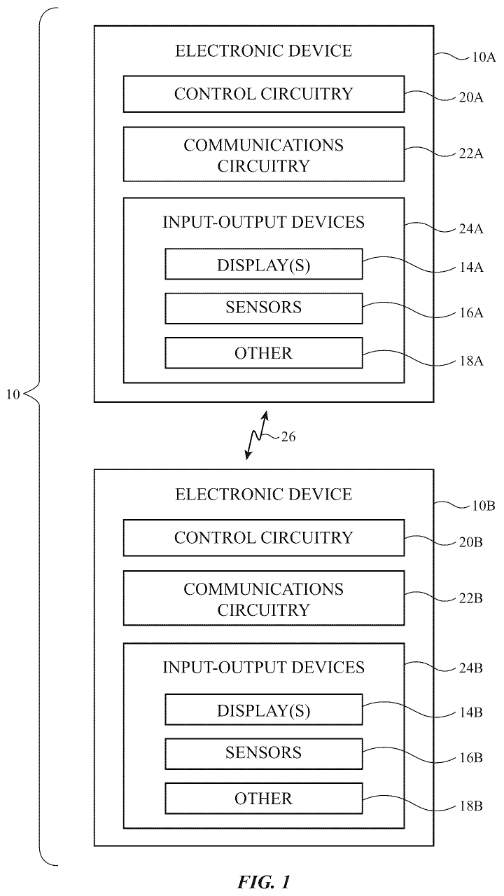

FIG. 1 is a schematic diagram of an illustrative electronic device that may include one or more modular components. Electronic device 10 of FIG. 1 may include a first component such as electronic device 10A and a second component such as electronic device 10B.

As shown in FIG. 1, electronic device 10A (sometimes referred to as a first component or a first device) may include control circuitry 20A, and electronic device 10B (sometimes referred to as a second component or a second device) may include control circuitry 20B. Control circuitry 20A and 20B may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20A and 20B may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20A may use display(s) 14A and other output devices in providing a user with visual output and other output. If desired, control circuitry 20B may use display(s) 14B and other output devices in providing a user with visual output and other output. This is merely illustrative. If desired, component 10B of device 10 may not include a display.

To support communications between device 10 and external equipment, control circuitry 20A may communicate using communications circuitry 22A and control circuitry 20B may communicate using communications circuitry 22B. Circuitry 22A and 22B may include antennas, radio-frequency transceiver circuitry, and other wireless communications circuitry and/or wired communications circuitry. Circuitry 22A and 22B, which may sometimes be referred to as control circuitry and/or control and communications circuitry, may support bidirectional wireless communications between device 10 and external equipment (e.g., a companion device such as a computer, cellular telephone, or other electronic device, an accessory such as a point device, computer stylus, or other input device, speakers or other output devices, etc.) over a wireless link. For example, circuitry 22A and 22B may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a Bluetooth® link, a WiFi® link, a wireless link operating at a frequency between 10 GHz and 400 GHz, a 60 GHz link, or other millimeter wave link, a cellular telephone link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Circuitry 22A and 22B may support bidirectional wireless communications between devices 10A and 10B over wireless link 26 (e.g., a wireless local area network link, a near-field communications link, or other suitable wired or wireless communications link (e.g., a Bluetooth® link, a WiFi® link, a 60 GHz link or other millimeter wave link, etc.).

Devices 10A and 10B may include circuitry for transmitting and/or receiving wired and/or wireless power. For example, wired power may be conveyed between devices 10A and device 10B through a charging port, and/or wireless power may be conveyed between devices 10A and 10B through capacitively coupled contacts and/or an inductive charging coil. In configurations in which wireless power transfer is supported between devices 10A and 10B, contacts (e.g., metal pads) may capacitively couple with one another (without forming ohmic contact) to allow power to be transferred, and/or in-band wireless communications may be supported using inductive power transfer coils. Inductive power transfer techniques may be used (e.g., wireless power can be transmitted using one or more wireless power transmitting coils in device 10B and/or 10B and transmitted wireless power signals can be received in a power receiving circuit in device 10A and/or 10B using a power receiving coil). Received alternating-current wireless power signals from device 10A and/or 10B can be converted to direct-current power using a rectifier in device 10A and/or 10B for charging a battery and/or for powering circuitry in device 10A and/or 10B. In configurations in which the power receiving circuit of device 10A and/or 10B receives power via a wired connection (e.g., using terminals), the power receiving circuit in device 10A and/or 10B may provide the received power to a battery and/or other circuitry in device 10A and/or 10B.

Device 10A may include input-output devices such as devices 24A and device 10B may include input-output devices such as devices 24B. Input-output devices 24A and 24B may be used in gathering user input, in gathering information on the environment surrounding the user, and/or in providing a user with output. Devices 24A and 24B may include one or more displays such as display(s) 14A and 14B, respectively. Display(s) 14A and 14B may include one or more display devices such as organic light-emitting diode display panels (panels with organic light-emitting diode pixels formed on polymer substrates or silicon substrates that contain pixel control circuitry), liquid crystal display panels, microelectromechanical systems displays (e.g., two-dimensional mirror arrays or scanning mirror display devices), display panels having pixel arrays formed from crystalline semiconductor light-emitting diode dies (sometimes referred to as microLEDs), and/or other display devices. If desired, component 10B may be display-free and display 14B may be omitted.

Sensors 16A in input-output devices 24A and sensors 16B in input-output devices 24B may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, sensors 16A and 16B may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, electromyography sensors to sense muscle activation, facial sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.

If desired, electronic device 10 may include additional components (see, e.g., other devices 18A in input-output devices 24A and other devices 18B in input-output devices 24B). The additional components may include haptic output devices, actuators for moving movable housing structures, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

If desired, the input-output devices 24B of device 10B may be complementary to or may otherwise enhance the input-output devices 24A of device 10A. For example, device 10A may be a cellular telephone with an antenna configured for cellular communications and a touch-sensitive display 14A. Device 10A may be slim and highly portable and may be used as a stand-alone electronic device. To keep device 10A within a compact form factor, some input-output devices may be omitted from device 10A. For example, device 10A may exclude visible light cameras, if desired, to reduce the thickness of device 10A. Device 10B may be one of multiple interchangeable components that are compatible with device 10A. Different devices 10B may have different input-output components that serve different needs. For example, device 10B may be a photography-focused component that includes one or more cameras, one or more interchangeable lenses, tactile camera controls, camera accessory mounts, and/or other photography-specific components. When the user wishes to use device 10 for photography, the user can couple the photography-focused component 10B to component 10A. Display 14A of device 10A may be used as a viewfinder for the camera of device 10B, if desired.

As another example, device 10B may be an outdoor-focused component that includes a rugged, weather-resistant enclosure, an interchangeable battery, location tracking circuitry (e.g., global positioning system receiver circuitry, enhanced global positioning system circuitry, and/or any other suitable long range communication circuitry), circuitry for off-grid communications, lights, beacons, a siren, sturdy accessory mounts, and/or other components that enhance outdoor usage of device 10. In some arrangements, device 10B may be an audio-focused component that enhances the audio capabilities of device 10A. For example, device 10B may include a loudspeaker that is larger and/or more powerful than the speaker of device 10A. Display 14A of device 10A may be used to display information related to the audio that is playing from the speaker in device 10B. Touch input on display 14A may be used to adjust media playback settings of the audio playing from device 10B. These examples are merely illustrative. In general, component 10B may include any suitable set of input-output devices 24B and may be used to enhance the functionality of device 10A depending on the user's needs.

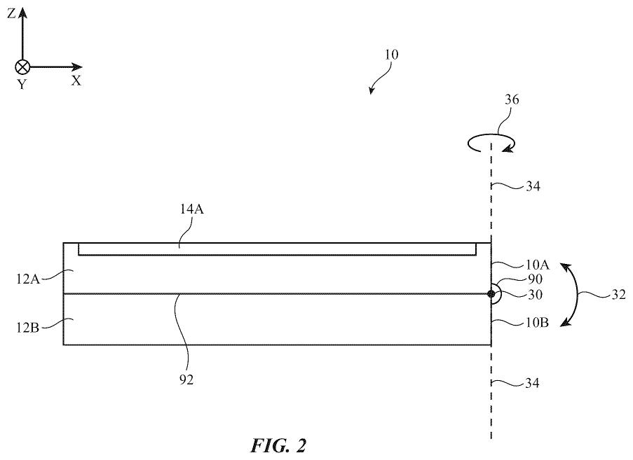

FIG. 2 is a side view of an illustrative electronic device 10 of the type shown in FIG. 1. In the illustrative configuration of FIG. 2, device 10 includes first component 10A (sometimes referred to as a first electronic device) and second component 10B (sometimes referred to as a second electronic device). Component 10A may include housing 12A and component 10B may include housing 12B. Housing 12A and/or 12B, which may sometimes be referred to as an enclosure, body, or case, may be formed of plastic, glass, ceramics, fiber composites, metal (e.g., stainless steel, aluminum, etc.), fabric, other suitable materials, or a combination of any two or more of these materials. Housing 12A and/or 12B may be formed using a unibody configuration in which some or all of housing 12A and/or 12B is machined or molded as a single structure or may be formed using multiple structures (e.g., an internal frame structure, one or more structures that form exterior housing surfaces, etc.). If desired, one or both of housing 12A and 12B may be a rectangular housing having a rectangular footprint in the X-Y plane of FIG. 2 (e.g., housing 12A and 12B may have a square footprint and display 14A may have a one-to-one aspect ratio), and/or housing 12A and 12B may have any other suitable shape (e.g., circular, oval, curved, etc.).

Components 10A and 10B are coupled together using an attachment structure such as attachment structure 90. In some arrangements, attachment structure 90 may be a hinge that allows component 10A to rotate relative to component 10B about axis 30 (e.g., parallel to the Y-axis of FIG. 2). If desired attachment structure 90 may include different and/or additional structures such as clips, magnets, screws, adhesive, and/or other attachment structures that allow component 10A to removably couple to component 10B.

In addition to being able to fold device 10A relative to device 10B about fold axis 30, device 10A may be reversible relative to device 10B. For example, device 10A may be configured to swivel about axis 34 (e.g., in direction 36) to reverse which side of device 10A faces device 10B and which side of device 10A faces away from device 10B. In the example, of FIG. 2, display 14A faces away from device 10B and is therefore located on the outside (e.g., exterior surface) of device 10. Outer housing surface 92 (e.g., an opaque surface) of housing 12A may face device 10B. Device 10A may be unfolded from device 10B to adjust the angle between device 10A and device 10B while display 14A faces away from device 10B. Axis 34 may be perpendicular to axis 30 or may have other angles relative to axis 30.

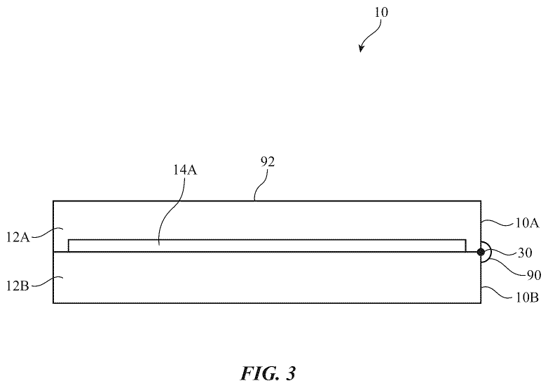

When the user wishes to protect display 14A (e.g., during travel and/or when device 10 is placed in a user's pocket), the user can flip device 10A so that display 14A faces toward device 10B, while outer housing surface 92 faces away from device 10B. This configuration is shown in FIG. 3.

As shown in FIG. 3, device 10 may be operable in a folded configuration in which display 14A is hidden within device 10. When the user flips device 10A from the display-out folded configuration of FIG. 2 to the display-in folded configuration of FIG. 3, display 14A faces toward device 10B and outer housing surface 92 faces away from device 10B. Device 10A may be unfolded from device 10B to adjust the angle between device 10A and device 10B while display 14A faces toward device 10B.

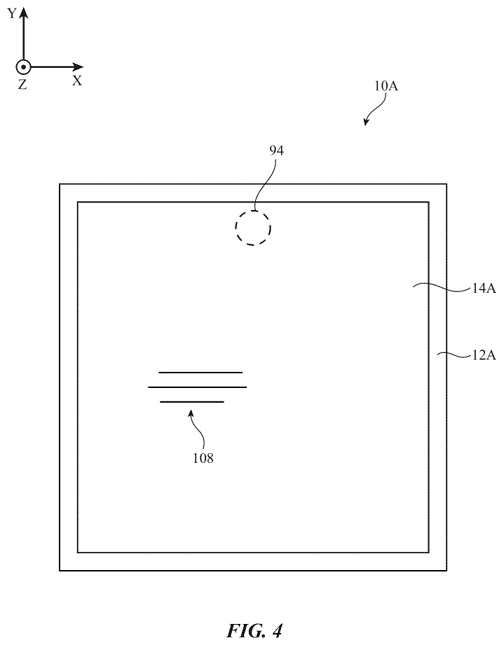

FIG. 4 is a top view of device 10A showing how device 10A may be used as a stand-alone electronic device when decoupled from device 10B. The user may provide touch input to display 14A while viewing display content 108 on display 14A. Display 14A may be used for cellular telephone configurations, browsing the internet, using software applications, and/or other tasks. If desired, device 10A may include one or more sensors such as sensor 94. Sensors in device 10A such as sensor 94 may include an infrared camera (e.g., a depth sensing camera), an optical proximity sensor, an ambient light sensor, a fingerprint sensor, and/or other sensors (e.g., sensors 16A of FIG. 1). As an example, sensor 94 may be an infrared camera configured for facial identification and/or other user authentication operations. If desired, device 10A may be free of visible light cameras and/or other circuitry (e.g., other circuitry that may be provided by device 10B when device 10B is coupled to device 10A) to keep housing 12A relatively compact. Display 14A may have a one-to-one aspect ratio as shown in FIG. 4 or may have any other suitable aspect ratio such as a two-to-one aspect ratio.

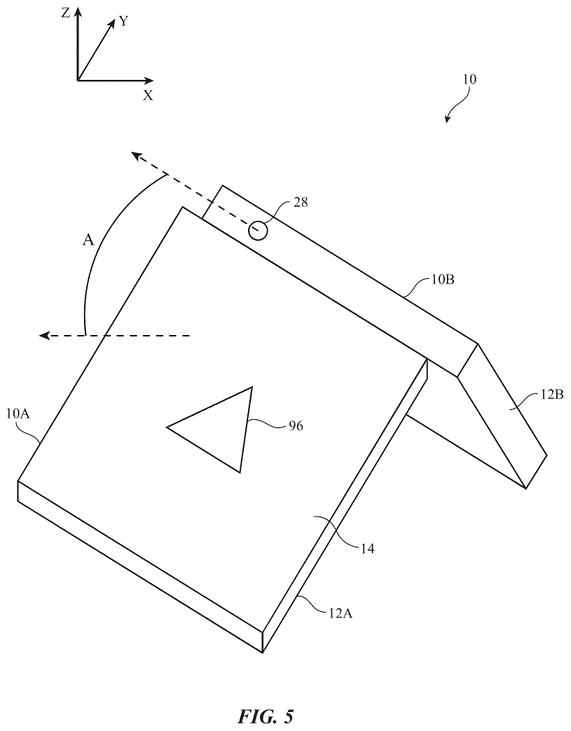

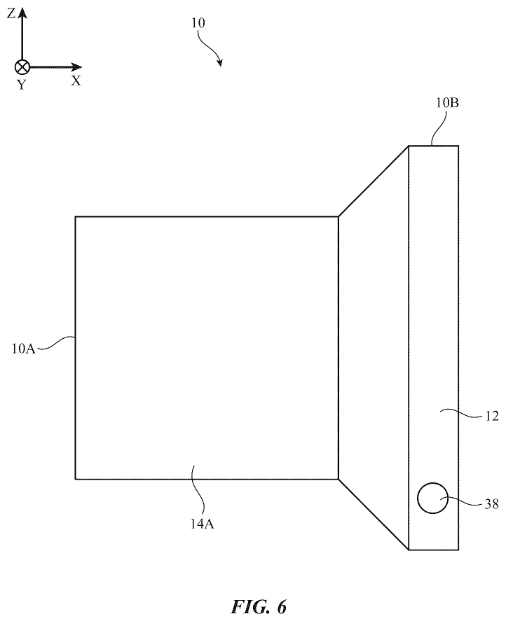

FIG. 5 is a perspective view of device 10 in a configuration in which device 10A has been coupled to device 10B to provide additional functionality to device 10. As shown in FIG. 5, device 10A may include display 14A and device 10B may include a camera such as camera 28. Camera 28 may be a visible light image sensor and/or any other suitable camera. When coupled together, device 10B may be configured to convey image sensor data captured by camera 28 to device 10A and device 10A may be configured to convey camera control signals to device 10B (e.g., over a wired or wireless communication path between devices 10A and 10B). Display 14A may serve as a viewfinder for camera 28 and may be configured to display a live camera feed of the images captured by camera 28. For example, display content 96 on display 14A may include a live video feed of images captured by camera 28 and/or may include camera control icons that may be used to adjust the settings of camera 28 (e.g., zoom, aspect ratio, color cast, etc.). Because the orientation of device 10A relative to device 10B can be adjusted (e.g., by flipping display 14A toward or away from device 10B and/or by rotating device 10A relative to device 10B about axis 30 of FIG. 2), the angle A between camera 28 and display 14A may be adjusted to any suitable angle (e.g., angle A may range from 0 degrees to 90 degrees, from 0 degrees to 180 degrees, from 0 degrees to 360 degrees, etc.). This type of freedom of motion may allow for a wide range of viewfinder postures that accommodate various subject positions. For example, camera 28 and display 14A may face in the same direction during a video call on device 10 so that the user of device 10 can be captured with camera 28 while the user views the video call on display 14A. When the user wishes to capture images of other subjects, the user can rotate device 10B relative to device 10A so that camera 28 faces away from display 14A, as shown in FIG. 6.

In the example of FIG. 6., device 10B has been flipped relative to device 10A so that display 14A faces toward device 10B. Camera 28 (which is hidden from view in FIG. 6) may face in the positive Y-direction of FIG. 6, whereas display 14A may face in the negative Y-direction of FIG. 6. Device 10B may include one or more input devices such as input device 38 (e.g., a button, a touch sensor, or other input device) for controlling camera 28 (e.g., input device 38 may be a shutter button) and/or a user may control camera 28 using input devices in device 10A such as a touch sensor in display 14A.

The postures of device 10A relative to device 10B shown in FIGS. 2, 3, 5, and 6 are merely illustrative. Device 10A may be positioned in any suitable orientation relative to device 10B (e.g., folded configurations of the type shown in FIGS. 2 and 3, partially unfolded configurations of the type shown in FIGS. 5 and 6, right angle configurations in which device 10A is perpendicular to device 10B, configurations in which device 10A and 10B are separated by an angle between 0 degrees and 90 degrees, between 90 degrees and 180 degrees, between 180 degrees and 360 degrees, between 0 degrees and 360 degrees etc.). The ability to rotate housing 12A relative to housing 12B while also allowing device 10A to flip relative to device 10B so that display 14A can face any direction relative to device 10B may allow for a wide range of postures with flexible viewfinder and camera orientations.

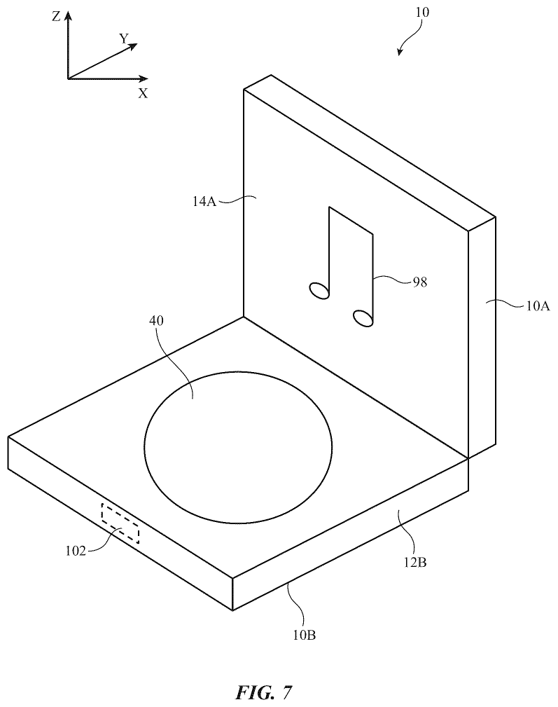

FIGS. 7, 8, 9, and 10 illustrate different types of interchangeable components 10B that may be attached to component 10A. Component 10A may be used as a stand-alone electronic device as shown in FIG. 4 or may be coupled to one or more modular components 10B. Component 10B may be one of multiple interchangeable components 10B that are compatible with component 10A. The user can select one of components 10B to couple to component 10A depending on the user's needs.

In the example of FIG. 7, component 10A has been coupled to a component 10B such as an audio-focused component that includes a speaker such as speaker 40 and one or more additional electrical components such as components 102. Speaker 40 may be a loudspeaker and/or may otherwise be a larger and/or more powerful speaker than speakers of device 10A. For example, device 10A may include a speaker for providing audio during a cellular telephone call. When the user wishes to use device 10A as a loudspeaker (e.g., to play music for a room of people), the user can attach device 10B to device 10A. When coupled together, speaker control signals may be conveyed from device 10A to device 10B (e.g., over a wired or wireless communications path) and audio may play from speaker 40. Display 14 may display content 98 related to the audio that is playing from speaker 40. The user can control the audio playing from speaker 40 using input devices on device 10B (e.g., input devices in components 102) and/or using input devices on device 10A (e.g., a touch sensor in display 14A). Components 102 may include audio-focused components such as media playback controls, a volume slider, a microphone for receiving voice commands, auxiliary cord and/or other audio cable inputs, memory for storing a library of songs, and/or other audio-focused components.

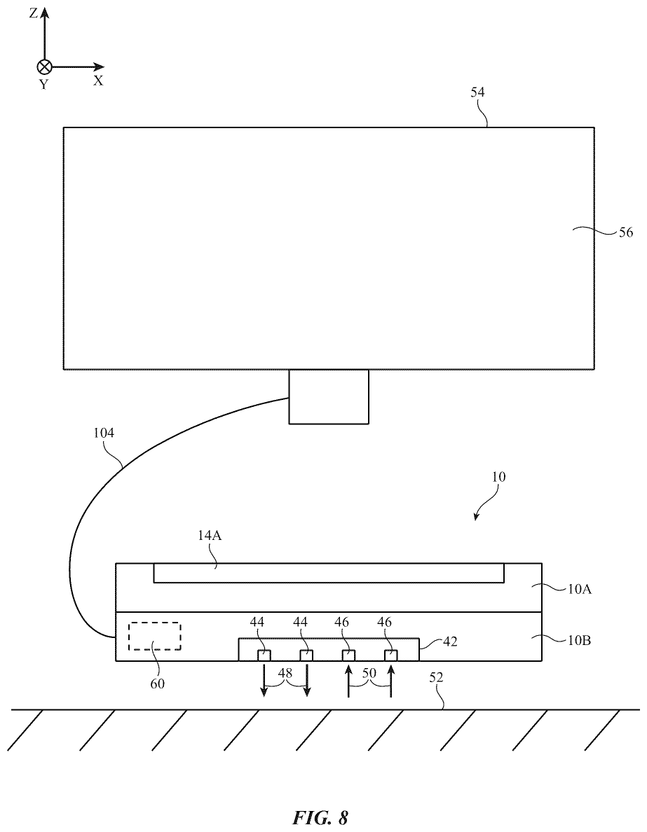

In the example of FIG. 8, component 10A has been coupled to a component 10B such as a computing-focused component that includes an input device such as input device 42 and one or more additional computing-focused components such as components 60. Components 60 may include additional storage and/or additional processing circuitry for enhancing the storage and/or processing capabilities of device 10A. For example, components 60 may include additional nonvolatile memory (e.g., flash memory or other electrically-programmable-read-only memory configured to form a solid state drive), volatile memory (e.g., static or dynamic random-access-memory), microprocessors, microcontrollers, digital signal processors, baseband processors and other wireless communications circuits, power management units, audio chips, application specific integrated circuits, etc. The processing power of component 10B may be equal to or greater than the processing power of device 10A so that device 10 can be used as a full computer on-the-go.

If desired, device 10 may be coupled to an external electronic device such as external electronic device 54 over a wired or wireless communications path such as communications path 104 (e.g., a cable or other communications path coupled between device 54 and device 10). External electronic device 54 may be a computer monitor with a display such as display 56. Display 56 may be used as an external display for device 10 (e.g., using the additional processing power provided by components 60 of device 10B). A user can control the content on display 56 using device 10. For example, a user may provide input to external electronic device 54 using one or more input devices on device 10A (e.g., a touch sensor in display 14A) and/or on device 10B (e.g., input device 42).

Input device 42 may be a device position monitoring component that monitors the position of device 10 on surface 52 (e.g., the position of device 10 in the X-Y plane in the example of FIG. 8). Input device 42 may be an optical flow sensor having one or more light sources such as light sources 44 that illuminate a portion of surface 52 with light 48 and having an image sensor or other light sensor such as light sensors 46 that receive reflected light 50 from surface 52. Based on the detected light and/or captured images, input device 42 may be configured to determine a location of device 10 on surface 52 and/or to measure movement of device 10 relative to surface 52 based on captured images of the illuminated portion of surface 52. In other arrangements, input device 42 may be a mechanical position sensor such as an encoded wheel that tracks movements of device 10 on surface 52. If desired, device 10A and/or 10B may include a trackpad that can be used to receive trackpad input for controlling external device 54.

Due to the presence of input device 42, device 10B may enhance the capabilities of device 10A by allowing device 10 to be used as an input device (e.g., a mouse) for external electronic device 54 while also providing additional computing power from components 60.

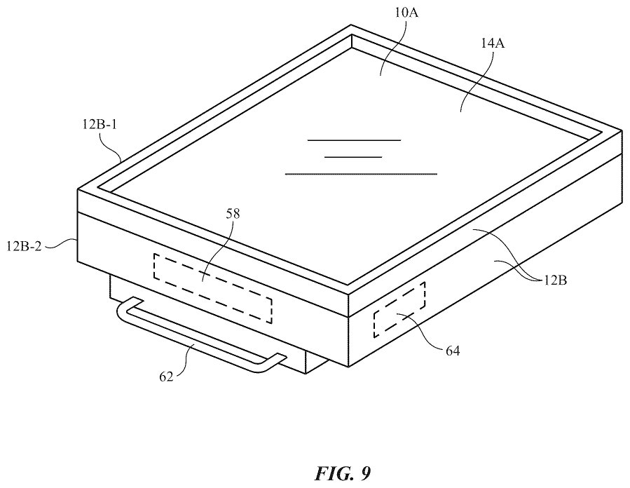

In the example of FIG. 9, component 10A has been coupled to a component 10B such as an outdoor-focused component that includes a rugged enclosure such as weather-resistant enclosure 12B, a replaceable battery such as battery 64, accessory mounts such as accessory mount 62, and one or more additional components 58 specific for outdoor use, sports, fitness activities, etc. Components 58 may include location tracking circuitry (e.g., global positioning system receiver circuitry, enhanced global positioning system circuitry, and/or any other suitable long range communication circuitry), communications circuitry for off-grid communications, one or more lights (e.g., flashlights), beacons, sirens, and/or other components. Accessory mount 62 may allow device 10 to be attached to a backpack, carabiner, and/or other item. Battery 64 may be a standard battery that is easily replaceable, so that a user can replace battery 64 with a new battery when device 10 is being used on a camping trip, hike, or other outdoor activity where electricity may not be accessible.

To protect display 14, enclosure 12B may include first and second housing portions such as housing portion 12B-1 and housing portion 12B-2. Housing portion 12B-1 may include a recess that receives device 10A so that display 14A is recessed within housing portion 12B-1 and protected from damage during a drop event. Housing portion 12B-2 may support components 58, battery 64, and accessory mount 62. If desired, housing 12B-2 may include protective covers for input-output ports and/or other sensitive components to protect the components from water damage and/or contaminants.

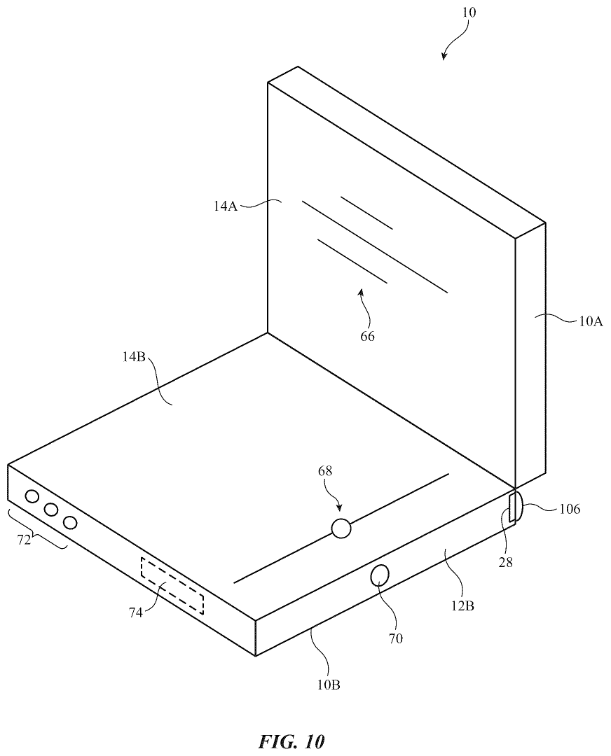

In the example of FIG. 10, component 10A has been coupled to a component 10B such as a photography-focused component that includes one or more cameras 28, one or more interchangeable lenses 106, one or more camera control input devices 70, one or more camera accessory mounting holes such as mounting holes 72 (e.g., mounting holes having an industry standard spacing to enable connectivity to common photography accessories such as a hot shoe accessory mount), and one or more additional photography components such as components 74. Photography components 74 may include a memory card slot for receiving a memory card, input-output ports for receiving cables commonly used for photography, and/or other photography-specific components. Input device 70 may be a touch sensor, a button, or other input device that allows a user to control camera 28 and/or to control other operations of device 10B and/or device 10A.

If desired, device 10B may include a display such as display 14B. Display 14B may be used as a complementary display to display 14A of device 10A. For example, display 14B may be used as a viewfinder that displays a live video feed or image preview of images captured by camera 28 and/or that displays camera controls such as camera controls 68. Display 14A may be used to display content 66 such as camera settings (e.g., F-stop settings, shutter speed settings, International Organization for Standardization (ISO) settings, etc.). This is merely illustrative. If desired, display 14A may be used as a viewfinder that displays a live video feed or image preview of images captured by camera 28 while display 14B may be used to display camera settings and/or camera controls. The ability to adjust the orientation of device 10A relative to device 10B (and thereby adjust the orientation of display 14A relative to camera 28) may allow for versatile shooting postures, as discussed in connection with FIGS. 5 and 6. If desired, display 14A and display 14B may be a single flexible (e.g., foldable) display that spans across hinge 30. Arrangements in which displays 14A and 14B are separate displays are sometimes described herein as an illustrative example.

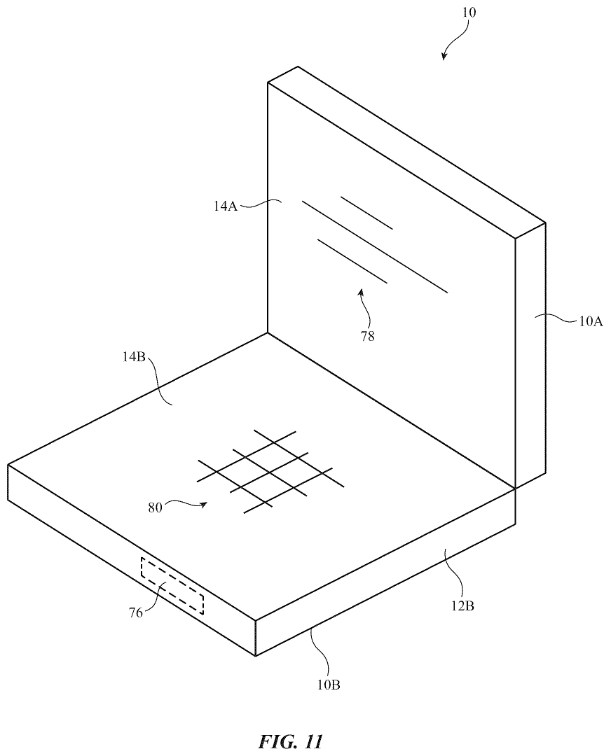

In the example of FIG. 11, component 10A has been coupled to a component 10B that includes a secondary display such as display 14B and one or more additional complementary components such as components 76. Display 14A may be used to display content 78 and display 14B may be used to display content 80. Display 14B may be an extension of display 14A, may be used as a secondary display to display 14A, may mirror display 14A, may be used to multitask by performing different and/or additional tasks than that of display 14A, may be used to display applications or content that is related to the content of display 14A, and/or may otherwise be used in conjunction with and/or independently of display 14A.

Display content 78 may be the same as display content 80 or may be different from display content 80. As an example, display 14B may be a touch-sensitive display and display content 78 may include a keyboard or other keys that receive touch input for controlling content 78 on display 14A. If desired, display 14A and display 14B may be a single flexible (e.g., foldable) display that spans across hinge 30. Arrangements in which displays 14A and 14B are separate displays are sometimes described herein as an illustrative example.

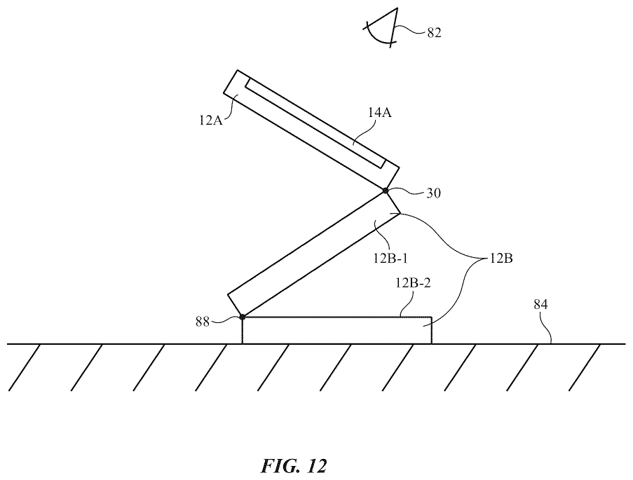

In the example of FIG. 12, component 10A has been coupled to a component 10B that enables one or more tri-folding postures. Housing 12B may include first and second housing portions such as housing portion 12B-1 and housing portion 12B-2 that rotate relative to one another about hinge axis 88. Housing 12A of device 10A may rotate relative to housing portion 12B-1 about hinge axis 30. With this type of configuration, device 10 may be configured to fold along both hinge axis 30 and hinge axis 88 to allow for additional postures such as that shown in FIG. 12. Housing 12B-2 may rest on surface 84, while housing 12B-1 is oriented at a non-zero angle relative to housing 12B-2 and while housing 12A is oriented at a non-zero angle relative to housing 12B-1. This allows a viewer such as viewer 82 to view display 14A on device 10A while housing 12B-2 serves as a stand for holding display 14A at the desired viewing angle.

The foregoing is merely illustrative and various modifications can be made to the described embodiments. The foregoing embodiments may be implemented individually or in any combination.

What is claimed is:

1. An electronic device, comprising:
a first component comprising a touch-sensitive display that receives touch input; and
a second component comprising a camera that is controlled by the touch input, wherein:
the first and second components are operable in a first mode in which the first and second components are coupled together along an axis about which the first component rotates relative to the second component; and
the first and second components are operable in a second mode in which the first and second components are decoupled from one another while the display displays content.

2. The electronic device defined in claim 1 wherein an angle between a first direction in which the camera faces and a second direction in which the display faces is adjustable.

3. The electronic device defined in claim 1 wherein the first component is operable in a first orientation in which the display faces toward the second component and a second orientation in which the display faces away from the second component.

4. The electronic device defined in claim 1 wherein the second component comprises an interchangeable lens aligned with the camera.

5. The electronic device defined in claim 1 wherein the display has a one-to-one aspect ratio.

6. The electronic device defined in claim 1 wherein the second component comprises an input device configured to control the camera.

7. The electronic device defined in claim 1 wherein the first component is free of visible light cameras and the second component is free of displays.

8. The electronic device defined in claim 1 wherein the first component is configured to rotate relative to the second component about an additional axis.

9. The electronic device defined in claim 8 wherein the axis is perpendicular to the additional axis.

10. The electronic device defined in claim 1 wherein the first component comprises wireless communications circuitry configured for cellular communications.

11. An electronic device, comprising:
a first component having a display;
an interchangeable second component that removably couples to the first component, wherein the display is configured to display content when the first component is decoupled from the interchangeable second component; and
a hinge coupled between the first component and the interchangeable second component that allows the first component to rotate relative to the interchangeable second component about a first axis, wherein the first component is configured to rotate relative to the interchangeable second component about a second axis between a first orientation in which the display faces away from the interchangeable second component and a second orientation in which the display faces toward the interchangeable second component.

12. The electronic device defined in claim 11 wherein the first and second axes are perpendicular.

13. The electronic device defined in claim 11 wherein the second interchangeable component has at least one input-output device that is not present in the first device and that is selected from the group consisting of: a visible light camera, a loudspeaker, and an optical flow sensor.

14. The electronic device defined in claim 11 wherein the second interchangeable component comprises a camera and an interchangeable lens aligned with the camera.

15. The electronic device defined in claim 11 wherein the second interchangeable component comprises a replaceable battery.

16. An electronic device, comprising:
a first component having a display; and
a second component removably coupled to the first component along an axis, wherein the second component has at least one item that is not present in the first device and that is selected from the group consisting of: a visible light camera, an interchangeable lens, a loudspeaker, an accessory mount, an optical flow sensor, and a replaceable battery.

17. The electronic device defined in claim 16 wherein the second component comprises first and second housing portions that rotate relative to one another about an additional axis.

18. The electronic device defined in claim 16 wherein the second component comprises first and second housing portions joined along the hinge axis and wherein the first component is received within the first housing portion.

19. The electronic device defined in claim 18 wherein the second component comprises additional items selected from the group consisting of: global positioning system receiver circuitry, a siren, a flashlight, and a beacon.

20. The electronic device defined in claim 16 wherein the optical flow sensor is configured to track a position of the electronic device on a surface and wherein an external display is controlled based on the position of the electronic device on the surface.
